(19) United States
(12) Patent Application Publication
(10) Pub. No.: US 2002/0056225 A1
(43) Pub. Date: May 16, 2002

(54) Technology for improving the utilization of sunlight by plants

(75) Inventors: Yosepha Shahak, Tel Aviv (IL); Michal Oren-Shamir, Rehovot (IL); Gal Elazar, Negev (IL); Aharon Bachar, Negev (IL); Yoav Guthman, Negev (IL); Arie Gemore, Negev (IL); Eugene E. Gussakovsky, Bat-Yam (IL)

Correspondence Address: BROWDY AND NEIMARK, P.L.L.C., 624 Ninth Street, N.W., Washington, DC, 20001, US

(73) Assignee: Polysack Plastic Industries (R.A.C.S.) Ltd., Negev (IL)

(21) Appl. No.: 09/948,948

(22) Filed: Sep. 10, 2001

Related U.S. Application Data
(60) Provisional application No. 60/231,132, filed on Sep. 8, 2000.
(60) Provisional application No. 60/234,371, filed on Sep. 20, 2000.
(60) Provisional application No. 60/306,858, filed on Jul. 23, 2001.

(51) Int. Cl. A01G 1/00

(52) U.S. Cl. 47/32.3

(57) ABSTRACT

Disclosed is a novel method for growing plants, including shade plants and sun plants. According to the invented method, plants are provided with light that includes indirect light and direct light, the ratio therebetween is greater than in natural light, at least in the PAR region. Such light may be provided to the plants by growing them under suitable shade nets. Such nets are typically translucent.

### FIELD OF THE INVENTION

This invention relates to a method for growing plants, the method including light modification.

### BACKGROUND OF THE INVENTION

It is well known that green terrestrial plants are highly receptive to incident light. Photosynthesis converts light energy into chemical energy required for plant growth and development. Because light is a plant's “food source”, it is not surprising that plants are exquisitely sensitive to quality and quantity of light. Manipulation of light for agricultural and horticultural purposes has a long history.

Initial efforts were directed towards controlling the quantity of light. Depending on the environmental niche in which a given plant species evolved, the plant may require high levels of direct sunlight or may require more or less dense shade. For plants requiring less than full sun, light level has been controlled by growing them under shading objects or trees. Where the plants require additional climate control as in a greenhouse, light absorbing and scattering “paint” has been applied to the glass or removable shades has been used. Where a glass house is not needed, lath and darkly colored textile or plastic netting has been used to modulate light intensity.

It is also known that plants respond to the quality (spectral distribution) of incident light. This response is mediated by a number of pigment-based receptor systems that control plant development. These effects have long been demonstrated to students studying plant physiology, but little commercial use has been made of these phenomena. There has been limited use of colored filters on greenhouses, but these filters are cumbersome and expensive. In addition, such filtration may excessively reduce the light required for photosynthesis.

Recently, it has been discovered by the inventors that shade nets (also called shade cloths) produced from colored components, that is netting that alters the spectral properties of light passing therethrough, may replace traditional nettings which merely reduce the quantity of light. Initial experiments were carried out on ornamental plants demonstrating changes in plant morphology in response to spectral alteration due to colorful netting.

### LIST OF PRIOR ART

The following is a list of prior art considered to be relevant as background to the invention. Appearance of a document in this list should not be construed as implying that the document is relevant to the patentability of the invention.

1. Oren-Shamir M., Gussakovsky E. E., Shpiegel E., Nissim-Levi A, Ratner K., Ovadia R., Giller Y. E. and Shahak Y. Coloured shade nets can improve the yield and quality of green decorative branches of Pittosporum variegatum. J. Hort. Sci. Biotech. 76: 353-361.

2. Shahak, Y., Gussakovsky, E. E., Shpiegel, E., Gal, B., Nissim-Levi, A., Giller, Yu., Ratner, K. and Oren-Shamir, M. (1999) Colored shade nets can manipulate the vegetative growth of ornamental plants. International Workshop on Greenhouse Techniques Towards the 3^{rd} Millennium. Haifa, Israel. (abstract)

3. Oren-Shamir, M., Gussakovsky, E. E., Shpiegel, E., Matan, E., Dory, I., and Shahak, Y. (2000) Colored shade nets can manipulate the vegetative growth and flowering behavior of ornamental plants. 97^{th} International Conference of ASHS, Orlando, Fla. HortScience 35 (3) 503. (abstract)

4. Shahak, Y., Gussakovsky, E. E., Shpiegel, E., Matan, E., Dory, I., and Oren-Shamir, M. (2000) Colored shade nets can manipulate the vegetative and flowering development of ornamental plants. Proc. 15th Internat. Congr. for Plastics in Agriculture and the 29^{th} National Agricultural Plastics Congress (W. J. Lamont, ed.), Hershey, Pa., p. 361. (abstract)

5. Batchauer A. 1998. Photoreceptors of higher plants. Planta, 206: 479-492.

6. Beggs C. J. and Wellman E. (1994) Photocontrol of flavonoid biosynthesis. In: Photomorphogenesis in Plants (Kendrick R. E. and Dronengerg G. H. M. eds.) pp. 733-751, Kluwer Academic Publishers, Boston.

7. Kasperbauer, M. J. (1994) Light and plant development. In: Plant-environment Interactions. Wilkinson R. E. (Ed.) Marcel Dekker Inc. NY. pp. 83-123.

8. McMahon, M. J., Kelly, J. W. and Decoteau, D. R., Young R. E. and Pollock, R. K. (1991) Growth of Dendranthema x grandiflorum (Ramat.) Kitamura under various spectial filters. J. Amer. Soc. Hort. Sci. 116: 950-954.

9. Mohr H. (1994) Coaction between pigment systems. In: Photomorphogenesis in Plants (Kendrick R. E. and Dronengerg G. H. M., eds.) pp. 353-373, Kluwer Academic Publishers, Boston.

10. Mortensen L. M. and Moe, R. (1992) Effects of selective screening of the daylight spectrum, and of twilight on plant growth in greenhouses. Acta Hort. 305: 103-108.

11. Mortensen L. M. and Stromme, E. (1987) Effects of light quality on some greenhouse crops. Scientia Hortic. 33: 27-36.

12. Rajapakse N. C. and Kelly J. W. (1992) Regulation: of Chrysanthemum growth by spectral filters. J. Amer. Soc. Hort. Sci. 117: 481-485.

13. Rajapakse N. C. and Kelly J. W. (1994). Influence of spectral filters on growth and postharvest quality of potted miniature roses. Scientia Hort. 56: 245-255.

14. Rajapakse N. C., McMahon M. J. and Kelly J. W. (1993). End of day far-red light reverses height reduction of chrysanthemum induced by CuSO4 spectral filters. Scientia Hort. 53; 249-259.

15. Rajapakse N. C. and J. W. Kelly. (1995) Spectral filters and growing season influence growth and carbohydrate status of Chrysanthemum. J. Amer. Soc. Hort. Sci. 120: 78-83.

16. Rajapakse N. C., Young, R. E., McMahon M. J. and Oi, R. (1999). Plant height control by photoselective filters; current status and future prospects. Hortechnology, 9: 618-624.

17. Tatineni A, Rajapakse N C, Fernandez R T and Rieck J R (2000) Effectiveness of plant growth regulators under photoselective greenhouse covers. J. Amer. Soc. Hort. Sci. 125; 673-778.

18. Thomas, B. (1981) Specific effects of blue light on plant growth and development. (Literature review). In: Plants and the daylight spectrum, pp. 443-459.

19. Van Haeringen, C. J. (1998) The development of solid spectral filters for the regulation of plant growth. Photochem. Photobiol. 67: 407-413.

20. Warrington, I. J. and Mitchell, K. J. (1976) The influence of blue- and red-biased light spectra on the growth and development of plants. Agric. Meteorol. 16: 247-262.

21. U.S. Pat. No. 5,022,181 “Method an apparatus for use in plant growth promotion and flower development”.

22. U.S. Pat. No. 5,097,624 “Netting for crop protection”.

23. U.S. Pat. No. 5,953,857 “Method for controlling plant growth”.

24. U.S. Pat. No. 4,895,904 “plastic sheeting for greenhouse and the like”

25. EP 0 481 870 “Crop Shelter”.

26. DE 3,339,293 “Method and cover for protecting plant cultivations against harmful incoming heat radiation in summer and/or harmful heat radiation in colder seasons”.

Glosary

The following terms will be used throughout the description and claims and should be understood in accordance with the invention to mean as follows:

Translucent net—a net made of filaments fabricated from a translucent material, which transmits at least 5% of the visible light. For example, the gray net used according to the invention differs from a conventional black net by the fact that the former transmits more than 5% of the visible light falling on a sheet from which the net filaments are fabricated, while the latter does not.

Light quality—the spectral properties of the light, as well as its relative content of indirect light and its thermal properties.

Indirect light—light that reaches a plant from directions other than the undisturbed sunbeams. Indirect light includes diffused, scattered and reflected light.

Light-modifying net—a net that can modify light quality (namely, spectral, scattering, relative content of indirect light, and/or thermal properties), in addition to the reduction of light quantity, achieved by nets in general. The spectral modification by a light-modifying net may be, for example, in the visible and far red range (400-800 nm), and/or the ultra violet (UV—B/A, 280-400 nm) and/or the infrared (NIR, 0.8-2.5□m and IR, 2.5-80□□m) A light-modifying net may appear colored to the human eye, but is not necessarily so.

Coloration (of fruit)—intensity and/or uniformity of color distribution on the fruit surface.

Variegation (of leaves)—the relative leaf area decorated with a non-green color.

Emergence—percentage of germinating or surviving plants from the total of sown seeds or transplanted saplings.

Shading—percentage of light in the photosynthetically active radiation (PAR, 400-700 nm) region retained by the net. A net with certain shading may typically be replaced by a similar net having a shading which is higher or lower by 5%. For example, a red net of 30% shading may be replaced by a red net having any shading between 25 and 35%, and the results are expected not to differ significantly.

Effective shading—percentage of a net shading in exploitation, which may be higher than the nominal shading, due to dust accumulating on the net. It may also vary during the day, with the sun angle. The nominal shading is determined when sunbeams are perpendicular to the net plane. Whenever a shading percentage is mentioned in the specification and claims, it refers to nominal shading, unless effective shading is explicitly indicated.

Sun plants—plants that are known to need a lot of light, and are conventionally grown with no shading net. Sometimes they may be grown under protective nets (like anti-hail, or anti-bird net), that typically provide shade of up to 15%.

Nursery plants—plants produced by a nursery in a first stage, before selling them for the consumer to be grown until maturity in a second stage. The second stage can be located in a field, orchard, garden, etc,

Nursery plants are propagated from seeds, cuttings, tissue culture, plantlets, etc. They need special care, and grown in high density. The quality of the nursery plant is detrimental for its performance in the second stage.

Fruit plants—plants that their main commercial value is in their fruit, such as apple trees, grapevines, strawberries, bell peppers and the like.

Edible plants—plants bearing any part that is used directly or indirectly as food or beverages. Be it the leaves, shoots, fruit, flowers, or roots.

Cut flowers—plants grown for fresh cut flower products.

### SUMMARY OF THE INVENTION

According to a first of its aspects, the present invention provides a method for growing plants. According to the invented method, plants are provided with light that includes indirect light and direct light, the ratio therebetween is greater than in natural light, at least in the PAR region. Such a light will be referred hereinafter as indirect component enriched, or ICE light.

The method of the invention is useful for influencing plant characteristics, such as emergence, vegetative growth, plant size, branching, branch elongation, dwarfing, plant vigor, development of the root system, development of the canopy, bushiness, leaf size and variegation, timing and quality of flowering, production period, fruit-set, fruit drop, sugar content of fruit acid content of fruit, size of fruit, content of bioactive compounds, content of aromatic compounds, sunburn, coloration, and post-harvest life.

One way to provide plants with ICE light is by growing them under a light-modifying net. Most light modifying nets studied so far by the inventors are also translucent.

Light-modifying translucent nets produce spectral alterations that are different from those produced by typical optical filters. The nets produce a mixture of light of both altered and unaltered quality. This may appear to be similar to a weak filter, however, unlike a weak filter the unaltered and spectrally altered light leaves the netting and strikes the plant at different angles, to produce ICE light. The light modifying nets may selectively absorb light of certain wavelengths. While pigments can be selected to absorb or transmit virtually any wavelength or wavelength range, it has been found that four more or less broad wavelength bands are of use in the present invention. These are 1) ultra-violet (UV) (280-400 nm); 2) visible light (400-700 nm); 3) Far Red (FR) (700-800 nm); and 4) thermal radiation (IR) (800 nm to 80 μm). Light-modifying translucent netting allows one to achieve unique combination of incident light in which unaltered direct light is combined with indirect light of increased intensity that may also be spectrally altered, preferably in one or more of the wavelength bands specified above.

Typically, the ratio of indirect/direct light is increased by a translucent net, such as yellow, red, green, and blue translucent nets. Translucent neutral nets, which absorb light of all the visible wavelengths to a similar extent, such as the white, pearl, and gray net may also be used in the method of the invention, even though they do not have visible color much different than white (white and pearl) and black (gray), The reflective net used in the experiments described below, which is practically opaque, may also be used according to the present invention. So is any other net or means that is effective in providing ICE light.

According to the invention, the nets may be applied in any position that increases the indirect/direct light ratio, such as horizontal covering, zig-zag roofs, covering a greenhouse, or under a greenhouse roof. In particular, the inventors found that nets suspended 1 m, preferably 1.5 m or more above the plant canopy are especially efficient. In such spacious constructions as well as in fully or partially open walls, microclimate effects of the nets were found to be negligible. However, when used in constructions closed from all sides, the nets may induce secondary effects on the plant microclimate, and these secondary effects may sometimes be undesirable.

The method according to the invention may be used with any kind of plant, such as edible plants (fruit, leaves, stems and root crops), cut flowers, and nursery plants. It should be noted that the method of the invention is not restricted to shade plants. Rather, it may also be applied to sun plants. In this context it should be explained that while the method of the invention results in reduction of the intensity of direct light reaching the sun-exposed parts of the canopy, it may also increase the intensity of indirect light, which is better reaching the inner parts of the canopy. Under suitable conditions, (usually shading of between 20 to 40%) the increase of indirect light may compensates at least partially, for the loss of direct light. The outer canopy of a sun plant is usually subjected to excessive solar radiation, which causes photodamage in leaves and fruit, while the inner canopy of sun plants suffers sub-optimal light intensity, which limits productivity. Sun plants thus benefit from the special kind of shading provided by the nets used according to the present invention, by both less excessive light on the outer canopy, and more light intercepting into the inner canopy. These two benefits are in addition to the possibility to enjoy light having modified spectral and/or thermal properties.

According to another aspect of the present invention there is provided a plantation or nursery, wherein plants are grown according to the method of the invention. In particular, the plantation and the nursery according to this aspect of the invention are covered by a light-modifying shade net. The shade net is preferably covering the plantation or nursery to form a spacious construction, preferably with fully or partially open walls. The light-modifying shade net is preferably positioned at least 1 m, preferably 1.5 m. or more, above the canopy of the said plant. The light-modifying shade nets may be applied in, any position that provides ICE light, such as horizontal covering, zig-zag roofs, and the like.

### BRIEF DESCRIPTION OF THE DRAWINGS

In order to understand the invention and to see how it may be carried out in practice, some experiments will now be described, by way of non-limiting example only, with reference to the accompanying drawings, in which:

FIGS. 1A and 1B are graphs showing spectra of the light reaching the ground under several nets useful according to the invention (vs. full sunlight). The black not spectrum is shown for comparison. The spectra were measured in a clear mid day in July by a spectroradiometer;

FIG. 2 is a graph showing the average sugar content in Superior table grapes grown at the Jordan (hot) valley, measured a week prior, and at the commercial harvest, about 2 month after application of four different nets. Sugar content was measured as the total soluble solids (TSS);

FIGS. 3A to 3D are graphs showing the effect of 7 translucent light-modifying nets on the average cluster (bunch) weight (FIG. 3A), average single berry weight (FIG. 3B), fruit sugar (FIG. 3C) an acid (FIG. 3D) content in Superior table grapes. The vineyard is located in the foot hills region of Israel, having milder climate than the Jordan valley, where the grapes of FIG. 2 were grown. The experimental vines were similar in their initial fruit load (i.e. number of clusters per vine). Different letters above the colmuns indicate statistical significance difference factor P>0.95 by Student test;

FIG. 4 is a graph showing the effect of 6 light-modifying nets on peach (Hermosa variety) fruit yield at each one of four selective harvests. Yield is expressed as kg/tree (FIG. 4A) and number of fruit per tree (FIG. 4B). in the selective harvests only fruit of commercial size was picked. The relative yield of the first two harvests is indicated as % of the total yield for each light-modifying translucent net. The experiment site is located in a commercial orchard in the central area of Israel. The nets were applied about 6 weeks prior to harvest, after fruit thinning;

FIGS. 5A and 5B are graphs showing the effect of several translucent nets on the red coloration of the peach fruit harvested in the second selective harvest of the Hermosa peach experiment. Coloration was analysed visually, as the relative fruit area covered by red color (FIG. 5A) and by rating the color intensity (FIG. 5B) for 80 fruits per net.

FIG. 6 is a photo of Banana plants from tissue culture after hardening for 3 weeks under commercial 50% black net (not according to the present invention, 4 plants on the right hand side) as compared to plants hardened under a 50% Red net according to the present invention (8 plants on the left hand side).

### DETAILED DESCRIPTION OF SPECIFIC EMBODIMENTS

The following are experiments that exemplify the method of the invention being successfully applied to several kinds of plants to achieve a variety of effects, mutually controlled by mutually different physiological processes.

The Nets

The nets used in all the following experiments are red, yellow, gray, black, blue, reflective, white and pearl, all manufactured by Polysack Plastic Industries (R.A.C.S) Ltd. Israel. The reflective net was the one marketed by Polysack under the trademark Aluminet®, and is described in WO96/10107. The pearl net is described in copending patent applications no. IL 135736 and U.S. Ser. No. 09/828,891. The pearl net is white to the eye, and hardly influence the visible spectra of light transferred through it. It is made of filaments that include air-filled micro-bubbles, which change the angle at which light passes through it. Other nets are light-modifying shade nets produced by Polysack with additives and knitting designs which provide the desired spectral properties, light scattering and % shading. Shade crops are conventially covered by nets of 50-90% shading, while sun crops, according to the invented method, are covered by 12-30% shading light-modifying nets. Hail net is conventionally a white net used to protect crops from hail, and results in 12% shading.

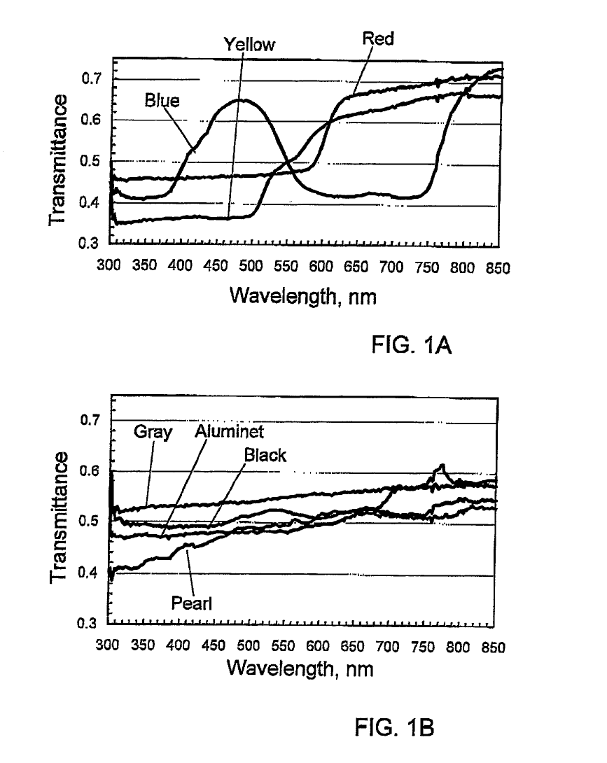

Spectra of the light reaching the ground under the nets (direct and indirect) vs. full sun-light are presented in FIGS. 1A and 1B. All features in the spectra may be attributed to the indirect light since the spectra of the direct light alone (relative transmittance vs. full sunlight, not shown) are all flat. Use of the black net is not in accordance with the present invention, and the data for this net are given for comparison only.

All nets (other than the black, which is not in accordance with the present invention) are made of translucent materials, and all increase the ratio of indirect to direct light reaching the ground underneath them.

Shading and scattering of the solar radiation by some of the nets in the photosynthesis active region (PAR) and in the UV (A+B) are given in table 1 below.

TABLE 1
Shading and scattering of the solar radiation by the nets.

| | PAR (400-700 nm) | | UV − (A + B) (300-400 nm) | |
|---|---|---|---|---|
| | Shade | Indirect light | Shade | Indirect light |
| Net | (%) | (% of total light) | (%) | (% of total light) |
| No net | | 18.2 | | 41.0 |
| Black | 55.4 | 18.2 | 55.6 | 44.8 |
| Gray | 50.8 | 22.1 | 54.5 | 40.5 |
| Aluminet | 55.6 | 29.3 | 58.6 | 48.0 |
| Green | 57.8 | 52.9 | 77.1 | 59.3 |
| Red | 56.2 | 45.9 | 74.3 | 51.0 |
| Blue | 59.0 | 47.8 | 78.6 | 48.7 |

Experiments and Results

A. Table Grapes

In the year 2000 the inventors have applied 4 nets over Superior grapes about 6 weeks prior to harvest, in a horizontal layout at the Jordan Valley area. This kind of grapes exemplifies, inter alia, the use of the method of the invention with plants that are conventionally grown under full sun, with no shade nets applied thereto. The Jordan valley is hot in the summer, and there is therefore a difficulty to reach die fruit sugar content required by the European market (15.5-16% TSS) early enough in the season. The inventors have applied the following shade nets to Superior grape vines: White 12% nominal shade (hereinafter White 12), White 22% nominal shade (hereinafter White 22), Red 30% shade (hereinafter Red 30) and Gray 30% shade (hereinafter Gray 30). Non-netted vines served as a control. White 12 actually shaded 18-20% of the light about a month after application, and White 22 shaded about 30% of the light. Shading by the Red and Gray nets was not much affected by the dust.

The main results obtained in the first season are as follows:

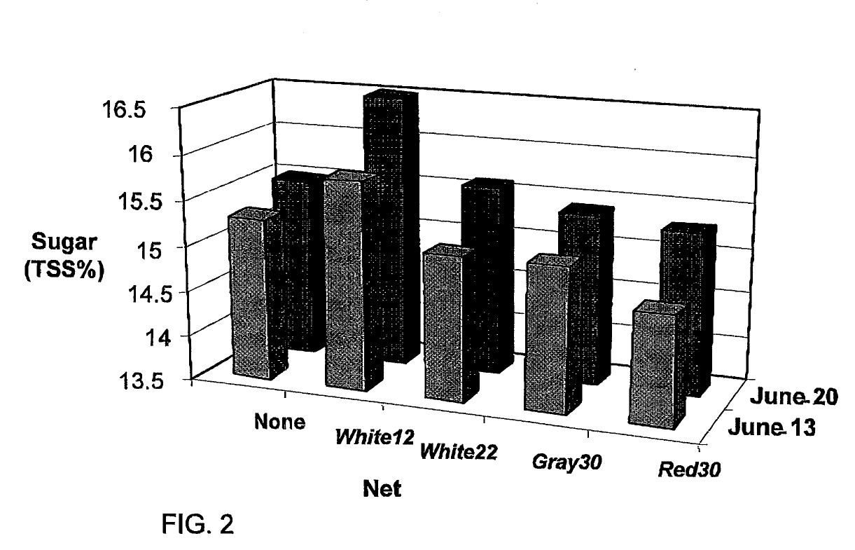

(1) Advanced maturation was observed under the White12 (sugar content of 16.5% compared with 15.3% in the control at harvest, FIG. 2);

(2) Delayed maturation by the Red net (FIG. 2);

(3) Improved uniformity of maturation of the berries within the cluster, under the Gray net (not shown);

(4) Enabling continuous increase in sugar content, with no saturation observed, under all nets. This was in contrast to controls, where the maturation did not progress beyond 15.3% sugar for several weeks. Eventually sugar is expected to reach the higher value in the uncovered control as well, but by then market prices drop, the fruit accumulates more external damage (from climate and pests), and the costly irrigation and fertilization need to be maintained longer.

(5) Reducing heat load within the canopy was observed under all netted vines. During early June, the White12 and White22 were found to reduce the daily maximal air temperature within the canopy by 1-2° C., while the Red 30 and Gray 30 were found to reduce this temperature by 2-4° C.

In 2001, another experiment was conducted in a commercial Superior vineyard in Ptahya, located in the center of Israel, under more moderate climate. The nets were applied in a zig-zag roof shape, to protect from hail, in addition to other effects. The nets were applied in mid March (upon dormancy break), and the fruit harvested by mid June. The tested nets included Red, Yellow, Blue, Gray, Pearl (all of 30% shading), white 22, white 12 and an unnetted control.

The main results obtained in the first year of this experiment are as follows:

(1) The clusters had better external quality under all nets, the less shading ones being less effective, compared with the uncovered (common practice) controls: less sunscalds, less wind scars, and less undeveloped small grapes.

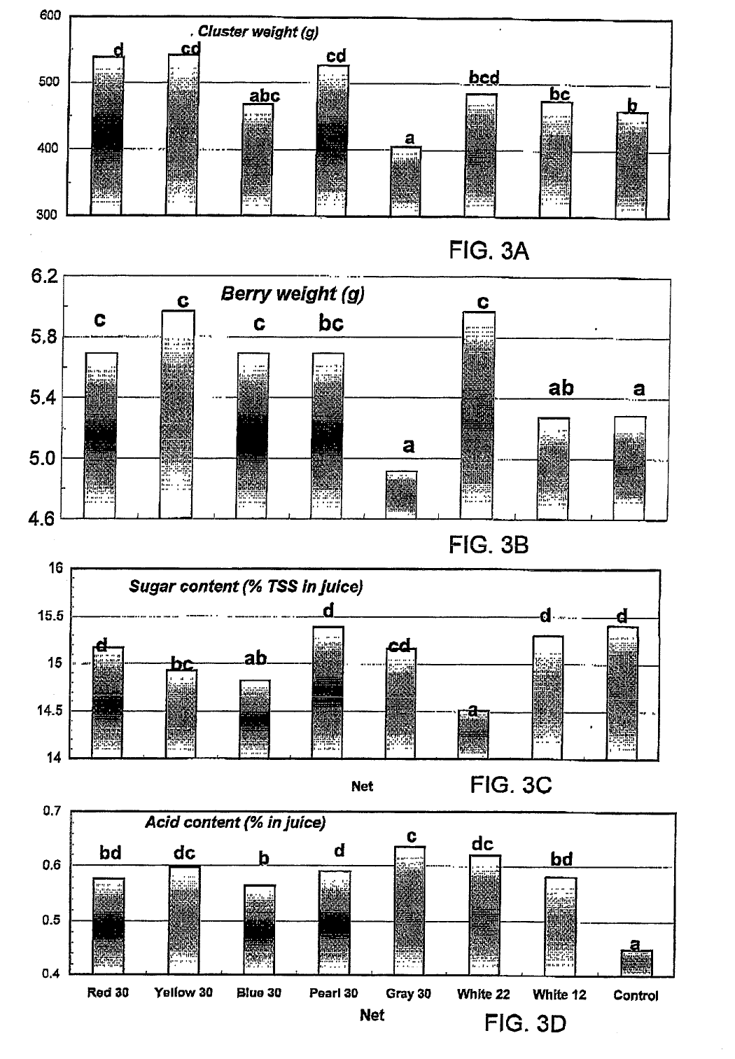

(2) The average cluster weight was significantly larger under the Yellow, Red and Pearl nets (about 540 g) compared with the uncovered control (460 g), while the gray net reduced the clusters weight (400 g). The enlargement and reduction of the cluster weight was mostly attributed to respective enlargement and reduction in the size of the berries (FIGS. 3A and B).

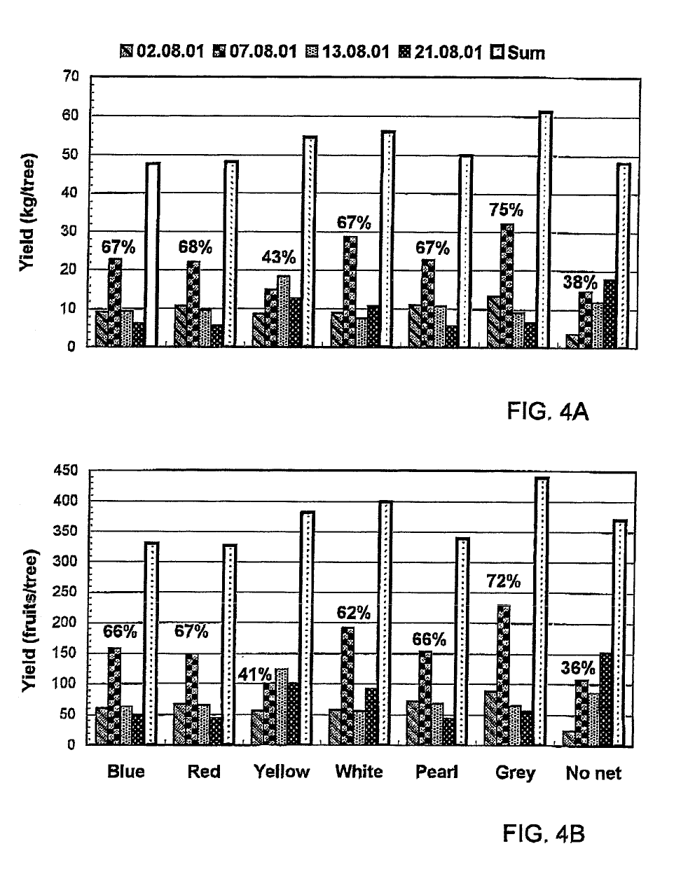

(3) The average sugar content under the Red, Pearl, Gray and White 12 was similar to the control, while the Yellow, Blue and White 22 contained less sugar, in descending order (cf. FIG. 4C).

(4) The acid content in, the control fruit (0.44% acid) was by far lower than in any of the netted vine grapes, which ranged between. 0.64% (Gray) and 0.57% (Blue, see FIG. 4D).

These results should be understood as a demonstration of the potential of several nets to induce specific improvements in the quality of table grapes. Larger berries and lack of external injuries have self-explanatory commercial benefits. So is the result of higher acidity, which appeals better to some markets (too low acidity feels tasteless), and, as generally known in the art, improves post-harvest life of the fruit. The effects of the Gray net might be considered undesirable for table grapes. However they may be advantageous for wine grapes, where small berries (providing relatively more skin, where most of the flavor compounds are concentrated) and higher acidity are desirable.

B. Apples

The experiment relating to apples is still ongoing. It is located in Kibbutz Malkiya in the Upper Gallilli in Israel. It includes the Blue, Red, Pearl (each one of 30% shading) nets, a white net (12% shade) and the commercial practice, which is non-netted. The experiment includes two apple varieties: a green one (Granny Smith) and a red one (Oregon Spur). What has already been clearly observed is as follows:

(1) All nets significantly reduced sunburns in the green variety (Granny Smith, which is susceptible to sunburns), the 30% ones being more effective than the 12%. It should be noted that while it is expected that shade nets protect crops from sunburns, nets according to the invention are particularly suitable for protecting sun plants from sunburns. This is so, because the method of the invention allows such a protection to be accomplished without significant reduction of the overall light reaching the plants, due to its increase of the non-direct light, which compensates (at least partially) for the loss of direct light. Since large parts of the canopy receive only non-direct light, these parts absorb more light than in the control, and the protection from sunburns is achieved not on the account of depriving the plant from light, which is vital to its productivity.

(2) The Red and Pearl nets significantly increased the fruit coloration of the red variety (Oregon Spur) compared with the uncovered control, while the Blue reduced the coloration. The term coloration refers to both the intensity of the red color, and the relative coverage of the fruit surface area.

Red coloration (i.e. accumulation of anthocyanines in the fruit skin) of apples is known to be regulated by both light quality and quantity, and to favor low temperatures. Thus, the increased coloration may suggest that the shade nets according to the invention may have an effect of increasing the amount of the light reaching the apples, which is a very surprising result to be obtained by a shade net. Additionally, it seems that this effect is achieved simultaneously with reduction of the fruit skin temperature and with more even distribution of the light around the fruit.

C. Peaches

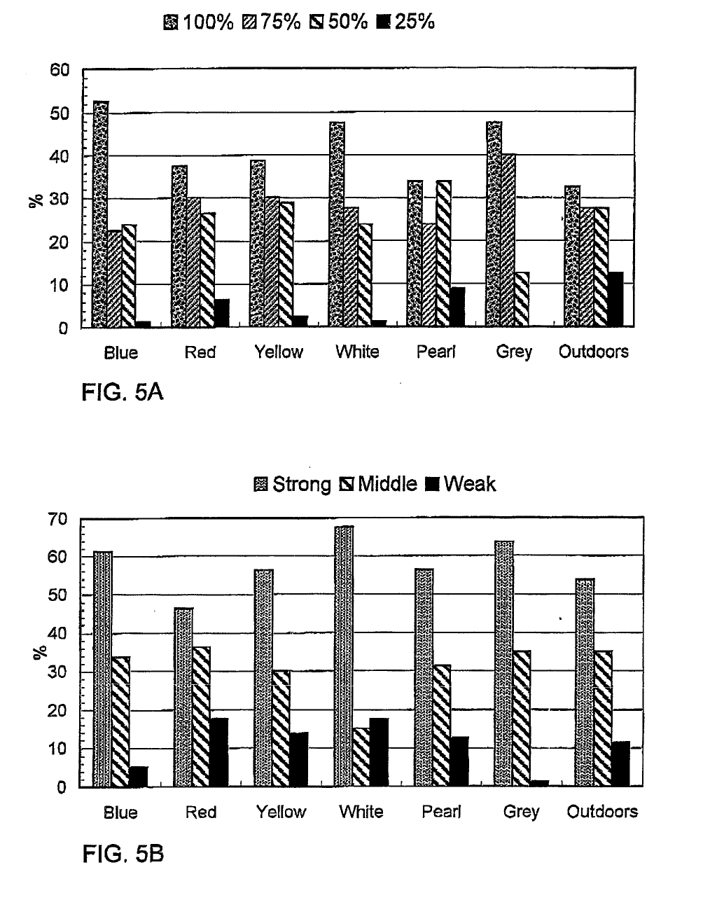

The experiment, which is located in a commercial orchard of the Hermosa peach variety in Re'em, Central Israel, includes 30% shading with Red, Yellow, Blue, Gray, and Pearl nets, a 22% White net, and the common uncovered practice. The light-modifying nets were applied on mid June 2001, about 6 weeks prior to the first selective harvest. The results show most advanced maturation under the Gray (about 75% of the fruit was picked already in the first two harvests, FIGS. 4A and B). The fruit under the Blue, Red, White and Pearl (but not the Yellow) was also significantly more advanced than the control. The fruit red coloration was also selectively improved by some of the nets (FIGS. 5A and B).

D. Pomegranates

A series of nets were tested with pomegranates: Aluminet (30 and 50% shade), White 22, Gray 30, Black 30. The White soon turned into about 30% shade, with the dust. Sunburn was reduced by 90% under all nets. However, the Aluminet 30 also resulted in better dispersion of the red color over the fruit surface. In the uncovered control the red color usually occurs in a patch at the sun-exposed side of the fruit. The Aluminet 50 caused smaller fruit, delayed fruit maturation and less red coloration, indicating too much shade.

E. Strawberries

It is observed that light-modifying netting of strawberries affects the harvest season, enabling to go on harvesting high quality fruit until early summer, in areas where the Harvest season of non-netted strawberries end in early spring. The Red and Pearl increased the percentage of top quality fruit.

F. Leafy Crops

F.1. Lettuce

Wide-leaf edible greens are usually grown commercially outdoors. They need a lot of light for good production. However, frequently excessive irradiation in the summer, causes sunburns as well as undesirable flowering, which reduces the quality of the edible parts. It was found by the inventors that partial shading (30-40%) by a netting according to the invention (i.e. netting that increases the portion of indirect light under it) provides an ideal solution, for answering the contradictory requirement reducing sunburns while not depriving the plants from light, which is important for their development. The method of the invention was found to improve both the yield and quality of the summer crops.

For example, in a small scale experiment in an experimental station in Uruguay (where the summer is hot and sunny) the following results were obtained for lettuce,

| | | | | Average | Average | |
|---|---|---|---|---|---|---|
| | | % | | leaf | plant | |
| Shade | % | flowering | % | weight | weight | |
| Net | emergence | plants | sunburns | (%) | gram | % |
| None | 50 | 17 | 33 | 100 | 158 | 100 |
| Black | 63 | 4 | 0 | 160 | 174 | 110 |
| Gray | 82 | 5 | 0 | 190 | 208 | 132 |
| Aluminet | 84 | 0 | 0 | 226 | 252 | 159 |
| Blue | 89 | 4 | 0 | 190 | 208 | 132 |

All nets were 40% shading, applied horizontally about 2 m above ground.

Another experiment was carried out in Israel (Gush Kattif) in two lettuce varieties: Iceberg and Nogah. The nets were applied on top of a plastic cover, which is sometimes required in order to allow the lettuce to be Kosher, which is of vital importance for Jewish consumers. Both the Red and Pearl nets increased the avarage size and weight of the lettuce heads by about 60% (Nogah) and 20% (Iceberg), compared with the common practice control.

F.2. Herbs

In fresh herbs, which are grown in Israel under plastic cover during the winter, emphasis was given to extend the production into the hot summer months, and even shift the crop to become a perennial crop (saving the cost of new planting every year). This was found to be achievable by replacing the plastic films by shade net according to the invention in the summer.

In an experiment earned out at the Jordan valley with 50% shading nets the main results obtained were as follows:

In Basil, the Red and Yellow nets increased the high quality yield (export quality) by 31% and 21%, respectively, over the black net, which is not in accordance with the present invention. Without any net there is no production at all in the summer. Another Basil experiment was carried out at the Bsor experimental station under 50% shading to test the Pearl net. The results were 210% commercial yield in the fisrt harvest and 136% in the second harvest under the Pearl, compared with the black net.

In Chives the Gray net increased the yield by 71% and the Red by 56%. Later it was found that less shading (40% rather than 50%) is actually better for this crop. Therefore, the relative improvement by the light-modifying nets is expected to be even better.

Observation trials in additional herbs show increased growth under the Red net in summer Oregano and Tarragon, and reduced flowering in Roccula under the Blue net. The Aluminet improved summer yield in Chinese parsley, Luwage, and Seige.

G. Nurseries

G.1. Propagation Material

In a first experiment, the utilization of the method of the invention to effect propagation material of nursery plants was performed with propagation of Banana. In the commercial process of banana plant production, the plantlets are first formed from tissue culture in the laboratory, then transferred into a greenhouse or net-house for hardening. A crucial rate limiting step is the development of the root system. In the experiment, the Red net caused dramatic stimulation of both the canopy and the root system during the hardening stage. Commercially, it means significant shortening of the hardening stage, and better survival after transplanting in the field.

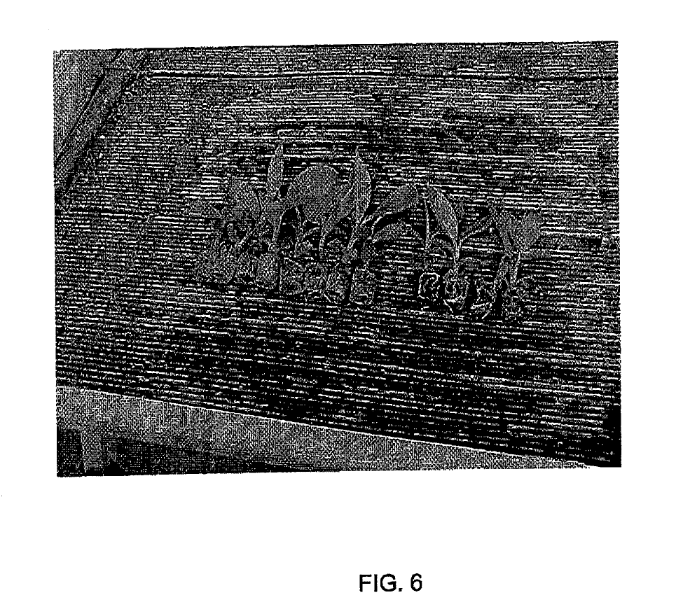

The results were not measured quantitatively, but the photo presented as FIG. 6 demonstrates it clearly: In the figure, Banana plants from tissue culture after hardening under commercial black net (4 plants on the right) is compared with plants hardened under a Red net (E plants on the left). It is clear that on the left the plugs show light-colored, well developed roots, while in the right plugs the dark soil mixture is mostly seen.

An additional high-quality crop, which can potentially benefit from improved saplings is Tea. Preliminary results from a nursery in Sri Lanka demonstrated pronounced advantage of the Red net, compared with the commercial shading.

The effects of the light-modifying net on the banana roots, which are not directly exposed to the light, strongly support further applications of the net technology in crops where the roots are the agricultural product. These include Ginseng, Ginger, etc. Manipulations of the quality of sunlight can thus be applied to improve both the vegetative production of these commercial roots, as well as their medicinal value. The biosynthesis and accumulation of many medicinal compounds is known to be regulated by light. Therefore, the method of the invention is expected to affect these parameters as well.

G.2. Tree Nurseries

The aim in nurseries is to get the largest, most vigor plant in the shortest time possible. There are numerous protecting coverage practices used in fruit tree nurseries: open field (no coverage), covering by clear plastic films for part, or whole year for warming, or plastic films for the winter and black shade net (plus, or minus the plastic) during the summer.

G.2.(i) Citrus Nursery

An experiment was carried out in a commercial citrus nursery in the central valley in California during the year 2000-2001. The experiment centered around two plants: Allen lemon, budded on Macrophila rootstock, and Barnfield navel orange budded on Tryfoliate rootstock, which is a very slow-growing rootstock. The trees were grown in standard 4 liters containers, drip irrigated and fertigated. The growing houses were 10 m.×30 m., and the trees were grown in 6 beds of six trees width each. The houses were covered by the light-modifying shade nets at Aug. 15, 2000. Winter plastic cover on top of the shade net was applied between Nov. 15, 2000 to Apr. 15, 2001. The data presented below were collected from 20 marked trees under each net.

Lemons

During the period of Aug. 15, 2000 to Mar. 12, 2001, which includes the winter, the trees under the Red net had their trunk girth enlarged by 3%, a result that is statistically significant. No data on elongation rate were gathered, since the common practice is to cut the tips of the lemon trees, in order to induce more branching.

Oranges

During the period of Aug. 15, 2000-Mar. 12, 2001, which includes the winter, the trees growing under all different shade cloth gained more height than the un-netted control, as specified below:

White +46%, statistically significant.

Gray +36%, statistically significant.

Aluminet +25%, statistically significant.

Pearl +24%, statistically significant.

Red +10%, not statistically significant.

The productivity of nurseries can be significantly improved by the proper use of translucent nets, as expressed in both the rate of production and the quality of the produced plants (i.e. better root system, more vigor plants, etc). The result is beneficial for both the nursery industries, as well as for the fruit growers. Planting plants of better quality leads to better survival and earlier fruit production by a newly planted orchard.

In view of all the experimental results obtained so far with nursery plants, it is expected that apple nursery trees will develop intensive branching when grown under a gray net, in particular one that provides between 30 and 50% shading.

H. Cut Flowers

Experiments were done in Habsor farm, Israel, wherein eight separate tunnels, each of 6 m×6 m area and 2.5 m height were constructed. Each tunnel was divided to two halves, one half was sowed with seeds of Lupinus luteus, and the other was planted with Ornithogalum dubium bulbs. The sowing and planting took part on October, 1999. The Lupinus luteus plants were harvested towards the end of February, 1999, between February 17 and 27, during full flowering of the plants. The dubium was harvested in March and April 2000.

An experiment with Lisianthus plants was carried out under similar conditions in the same place between July and September 1999.

All shading nets were designed to give 50% shadow in the PAR (400-700 nm) region, but in practice this number may vary because of dust. The anti-hale net creates only 12% shadow.

Influence on Vegetative Growth

In the parameter related to vegetative growth that showed most pronounced effect of the shading nets is the height of the plants grown under them. The data related to this parameter are summarized in table 2 below. Numbers in parenthesis represent standard deviations. Data are based on a samples of 30 plants each,

TABLE 2
Average height (in cm) of flowering plants grown according to
the invention under several nets. (black net is for reference only)

Ornithogalum dubuim

| Net | Lupinus luteus | March | April |
|---|---|---|---|
| Gray | 129.3 (6.3) | 28.73 (1.27) | 36.70 (0.97) |
| Aluminet ® | 133.0 (2.2) | 35.93 (1.36) | 38.50 (1.63) |
| Blue | 109.2 (1.9) | 40.70 (1.26) | 44.50 (1.59) |
| Yellow | 177.0 (2.8) | 33.90 (1.36) | 37.10 (1.67) |
| Red | 171.4 (2.6) | 35.67 (0.97) | 35.10 (1.07) |
| Black | 132.0 (2.0) | 32.70 (1.13) | 38.60 (0.72) |
| White 12% | 131.4 (1.8) | 26.90 (1.58) | 27.00 (1.26) |
| White 22% | 159.7 (2.0) | 29.53 (0.96) | 31.70 (1.10) |

In the Lisianthus experiment, length of flowering stems were found to be 10 cm longer under the red and the yellow net than under the black (reference) one. Plants grown under the yellow net were also exceptional in their heavier flower stems. Under the gray net, Lisianthus yielded the highest number of flowering stems per plant, compared with any other net. An important parameter determining the commercial value of cut flowers is the length and weight of the flowering stems. Higher yield of stems per plant (in the Gray) is also beneficial.

Influence on Flowering

The parameter related to flowering that showed most pronounced effect of the light-modifying nets is the flowering date of the Lupinus luteus grown under them. The data related to tins parameter are summarized in table 3 below. Initial flowering was defined as the date when 10 flowers per bed developed mature flowers. The effect on the flowering date was not related to the effect on the vegetative growth. Thus, while both Red and Yellow stimulated elongation to a similar extent, the Yellow induced a two weeks delay in flowering. The flowering date under the dwarfing (Blue) net was similar to the Yellow. Both stimulation and delay of flowering have commercial advantages.

TABLE 3
Flowering date of Lupinus luteus plants grown according to the
invention under several nets. (black net is for reference only)

| | Flowering date |
|---|---|
| Net | (day/month) |
| Red | 26/1 |
| Yellow | 9/2 |
| Gray | 25/1 |
| Hail | 3/2 |
| Pearl | 6/2 |
| Aluminet ® | 7/2 |
| Blue | 10/2 |
| Black | 25/1 |

1. A method for growing plants, comprising providing said plants with light including direct light (D) and indirect light (ID), wherein the ratio between indirect light and direct light (ID/D) is greater than the same ratio in natural light, at least in the PAR region, thus influencing predetermined plant characteristics.

2. A method according to claim 1, wherein light as defined in claim 1 is provided by growing the plants under a shade net.

3. A method according to claim 2, wherein said shade net provides between 10% and 35% shade.

4. A method according to claim 2, wherein said shade net is translucent.

5. A method according to claim 2, wherein said shade net is reflective.

6. A method according to claim 4, wherein said translucent shade net is light-modifying.

7. A method according to claim 4, wherein said shade net is white or pearl.

8. A method according to claim 2, wherein said shade net is suspended at least 1.5 m above the plant canopy.

9. A method according to claim 2 wherein, said shade net is suspended at least 1.5 m above the plant canopy.

10. A method according to claim 2, wherein said shade net forms fully or partially open walls.

11. A method according to claim 2, wherein said plants are sun plants.

12. A method according to claim 11, wherein said shade net provides 20% shading or more.

13. A method according to claim 11, wherein said sun plants are conventionally grown under protective net, which provide up to 15% shading, and said shade nets provide 30% shading or more.

14. A method according to claim 1, wherein said plant characteristics include at least one of the following: emergence, yield, vegetative growth, plant size, branching, branch elongation, dwarfing, plant vigor, development of the root system, development of the canopy, bushiness, flowering, maturation time, production period, sugar content of fruit, acid content of fruit, size of fruit, content of bioactive compounds, content of aromatic compounds, sunburn, coloration, variegation, and post-harvest life.

15. A method according to claim 14, wherein said parameters of plant characteristics include at least one of the following: emergence, yield, development of the root system, development of the canopy, flowering, maturation time, production period, sugar content of fruit, acid content of fruit, size of fruit, content of bioactive compounds, content of aromatic compounds, sunburn, coloration, variegation, and post-harvest life.

16. A method according to claim 14, wherein said parameters of plant characteristics include at least one of the following: emergence, yield, plant vigor, development of the root system, development of the canopy, maturation time, production period, sugar content of fruit, acid content of fruit, size of fruit, content of bioactive compounds, content of aromatic compounds, sunburn, coloration, variegation, and post-harvest life.

17. A method according to claim 1, where said plants are edible plants.

18. A method according to claim 17, wherein said plants are fruit bearing plants.

19. A method according to claim 18, wherein said plants are fruit trees.

20. A method according to claim 19, wherein said plant characteristics include: production period, yield, fruit size, sunburn, coloration, sugar content of fruit, and acid content of fruit.

21. A method according to claim 19, wherein said fruit trees are selected from the following: apples, pomegranates, citrus, grapes, and peaches.

22. A method according to claim 19, wherein said fruit trees are grown under a shade net providing 30% shading.

23. A method according to claim 21, wherein apple trees are grown under red or pearl net.

24. A method according to claim 23, to obtain increased sugar content in apples or to improve coloration of apples.

25. A method according to claim 21, wherein said fruit trees are grapes.

26. A method according to claim 25, wherein said plant characteristics are at least one of the following: maturation times yield, sugar content, acid content, size of berries, uniformity of berries, sunburn, wind scalds, weight of clusters, and post-harvest life.

27. A method according to claim 25, wherein said nets provide between 22% to 30% shade.

28. A method according to claim 25, wherein said grapes are wine grapes.

29. A method according to claim 28, wherein said wine grapes are grown under a gray shade net.

30. A method according to claim 25, wherein said grapes are grown under white shade net that provide 12 to 22% shade.

31. A method according to claim 25, wherein said grapes are grown under gray shade net or blue shade net for obtaining higher acidity and/or longer post-harvest life.

32. A method according to claim 28, wherein said wine grapes are grown under white shade net that provide 12% shade.

33. A method according to claim 28, wherein said wine grapes are grown under gray net, to obtain high acidity and small berries.

34. A method according to claim 30, wherein the plant characteristic is advanced maturation.

35. A method according to claim 19, wherein said fruit trees are peach trees.

36. A method according to claim 35, wherein said shade net is selected from red, yellow, blue, gray, and pearl, and white nets.

37. A method according to claim 36, wherein said shade nets provide 30% shade.

38. A method according to claim 36, wherein said white shade net provides 22% shade.

39. A method according to claim 36, wherein the plant characteristics include maturation time and coloration.

40. A method according to claim 17, wherein said edible plants are is a leaf crop.

41. A method according to claim 40, wherein the plant characteristic is at least one of the following: emergence, yield, sunburn, and flowering.

42. A method according to claim 40, wherein said leafy crop is lettuce.

43. A method according to claim 42, wherein said lettuce is grown under a shade net that provides shading of 30 to 40%.

44. A method according to claim 42, wherein said shade net is grey, red, or pearl.

45. A method according to claim 17, wherein said edible plants are strawberries.

46. A method according to claim 45, wherein said plant characteristic is the length of production period or the yield of high quality fruit.

47. A method according to claim 17, wherein said plants are herbs.

48. A method according to claim 47, wherein said plant characteristics are at least one of the following: production period, yield, content of bioactive compounds, content of aromatic compounds, and flowering.

49. A method according to claim 47, wherein said herb is one of the following: Basil, Chives, Oregano, Tarragon, Roccula, and Tea.

50. A method according to claim 47, wherein said nets have effective shading of 40% to 50%.

51. A method according to claim 47, wherein the valuable part of said herb is the root.

52. A method according to claim 51, wherein said herb is Ginseng or Ginger.

53. A method according to claim 51, wherein said plant characteristics are yield, root size, root content of nutrients and/or root content of bioactive compounds.

54. A method according to claim 19, wherein said fruit trees are pomegranate trees.

55. A method according to claim 1, wherein said plants are cut flowers.

56. A method according to claim 55, wherein the plant characteristic is at least one of the following: vegetative growth, length of the flowering stems, maturation time, flowering date, yield, number of flowering stems per plant.

57. A method according to claim 55, wherein said cut flowers include: Lupinus luteus, Ornithogalum dubium, and Lisianthus.

58. A method according to claim 57, wherein said cut flowers are Lupinus luteus or Lisianthus and said plant characteristic is weight of flowering stems.

59. A method according to claim 1, wherein said plants are nursery plants.

60. A method according to claim 59, wherein said plant characteristics include: development of the root system, rate of root system hardening, development of the canopy, plant vigor, plant height, and plant trunk girth.

61. A method according to claim 59, wherein said nursery plants are banana plantlets.

62. A method according to claim 59, wherein said nursery plants are citrus trees.

63. A method according to claim 59, wherein said nursery plants are apple trees.

64. A method according to claim 63, wherein said apple trees are grown under a gray shade net.

65. A method according to claim 64, wherein said gray shade net provides 30 to 50% shade.

66. A method according to claim 1, wherein said plant characteristic is the content of bioactive compounds and/or content of aromatic compounds.

67. A method according to claim 66, wherein said bioactive compounds are at least one of the following: phytonutrients, vitamins, and minerals.

68. A method according to claim 67, wherein the plant bioactive compound is a phytonutrient.

69. A method according to claim 68, wherein said phytonutrients include: phytoestrogens, polyphenols, and flavonoids.

70. A method according to claim 66, wherein tangerines are grown under shade nets for increasing content of the tangerine flavonoid.

71. A plantation or nursery, wherein plants are grown according to the method of claim 1.

72. A plantation or nursery according to claim 71, wherein plants are grown under a shade net suspended at least 1 m above the plant canopy.

73. A plantation or nursery according to claim 71, wherein plants are grown under a shade net suspended at least 1.5 m above the plant canopy.

74. A plantation or nursery according to claim 71, wherein said shade net forms fully or partially open walls.
